(19) United States
(12) Patent Application Publication
(10) Pub. No.: US 2026/0155713 A1
(43) Pub. Date: Jun. 4, 2026

(54) MOTOR

(71) Applicants: HYUNDAI MOTOR COMPANY, Seoul (KR); KIA CORPORATION, Seoul (KR)

(72) Inventors: Kam Chun LEE, Hwaseong-si (KR); Kwon Su SHIN, Hwaseong-si (KR); Jeong Uk AN, Hwaseong-si (KR); Ki Tack LIM, Hwaseong-si (KR); Yong Sok JANG, Hwaseong-si (KR); Kyung Ku YEO, Hwaseong-si (KR); Chee Mann KIM, Hwaseong-si (KR); Kyung Jun LEE, Hwaseong-si (KR); Sung Ho LEE, Hwaseong-si (KR); Jae Joon LEE, Hwaseong-si (KR); Hoan Ju YOO, Hwaseong-si (KR); Dong Su LEE, Hwaseong-si (KR); Yun Kyung HWANG, Hwaseong-si (KR); Jong Hun CHOI, Hwaseong-si (KR); Hong Wook LEE, Hwaseong-si (KR); Jae Young JEUN, Hwaseong-si (KR)

(21) Appl. No.: 19/352,853

(22) Filed: Oct. 8, 2025

(30) Foreign Application Priority Data
Dec. 2, 2024 (KR) 10-2024-0176267

(51) Int. Cl. H02K 11/25; H02K 1/14; H02K 3/34; H02K 3/50

(52) U.S. Cl. CPC H02K 11/25; H02K 1/14; H02K 3/345; H02K 3/50; H02K 2203/09

(57) ABSTRACT

A motor includes a stator including (i) a stator core, (ii) an insulator disposed at the stator core, and (iii) a coil wound around the insulator, a rotor configured to rotate relative to the stator, and a temperature sensor that is in contact with the coil and configured to measure a temperature of the coil. The temperature sensor has a first region and a second region that are spaced apart from each other in a circumferential direction of the temperature sensor and that are surrounded by at least one of the coil or an insulating member.

### CROSS-REFERENCE TO RELATED APPLICATION

This application claims priority to and the benefit of Korean Patent Application No. 10-2024-0176267, filed on Dec. 2, 2024, the disclosure of which is incorporated herein by reference in its entirety.

### TECHNICAL FIELD

The present disclosure relates to a motor, and more specifically, to a motor including a temperature sensor.

### BACKGROUND

A motor may include a stator and a rotor, where the rotor may rotate based on an electromagnetic interaction with the stator. In some cases, rotary force generated by rotating the rotor can be used as power of various mobilities.

In some cases, heat may be generated in a coil when a motor operates. The heat generated in the coil may be a factor for controlling the motor. For example, the output power of the motor can be adjusted according to a measured temperature of the coil. In some cases, a temperature sensor may be attached to the coil to measure the temperature of the coil. For instance, in a state in which the temperature sensor is attached to the coil, an adhesive may be applied in order to secure a fixing force between the coil and the temperature sensor. In some cases, when the temperature sensor is attached to the coil in this way, the temperature of the coil may be inaccurately measured.

For example, the temperature of the coil may be accurately measured at a region at which the temperature sensor and the coil are in contact with each other, but the temperature of an opposite region may be decreased due to the adhesive, and the temperature of an outer side of the adhesive may be decreased due to cooling. Thus, in some cases, the temperature of the coil may be measured lower than an actual temperature. When the temperature measurement of the coil is inaccurate, the motor may not be controlled to its optimal performance.

### SUMMARY

The present disclosure is directed to providing a motor in which a temperature of a coil of a stator can be accurately measured.

According to one aspect of the subject matter described in this application, a motor includes a stator including (i) a stator core, (ii) an insulator disposed at the stator core, and (iii) a coil wound around the insulator, a rotor configured to rotate relative to the stator, and a temperature sensor that is in contact with the coil and configured to measure a temperature of the coil. The temperature sensor has a first region and a second region that are spaced apart from each other in a circumferential direction of the temperature sensor and that are surrounded by at least one of the coil or an insulating member.

Implementations according to this aspect can include one or more of the following features. For example, the coil can be wound in a plurality of turns around the insulator, where the first region of the temperature sensor is in contact with any one turn of the plurality of turns of the coil, and the second region of the temperature sensor is in contact with another turn of the plurality of turns of the coil. In some examples, the second region of the temperature sensor is in contact with a last turn of the plurality of turns of the coil. In some examples, the first region of the temperature sensor is in contact with two or more turns of the plurality of turns of the coil.

In some implementations, the motor can further a fixing member that includes an insulating material and provides the insulating member, where the fixing member surrounds at least a portion of the temperature sensor and is in contact with the second region of the temperature sensor. In some examples, the fixing member can define an accommodation groove that accommodates the temperature sensor.

In some examples, the fixing member can include a heat transfer portion that is accommodated in the accommodation groove and is in contact with the coil, the heat transfer portion being made of a material configured to transfer heat from the coil. For instance, the heat transfer portion can include a curved portion including a contact region in contact with the temperature sensor, the contact region having a curvature corresponding to a curvature of an outer surface of the temperature sensor, and an extension portion that extends from the curved portion, that is spaced apart from the temperature sensor, and that is in contact with the coil.

In some examples, the accommodation groove can have a semi-cylindrical curved surface. In some examples, the fixing member can have a first surface in contact with the insulator.

In some implementations, the motor can further include a busbar connected to the coil, and a busbar mold that fixes the busbar and is in contact with a second surface of the fixing member. In some examples, the fixing member can include a protruding portion that protrudes in an axial direction of the stator and defines the first surface in contact with the insulator.

In some examples, the first surface and the second surface of the fixing member are spaced apart from each other in an axial direction of the stator.

In some implementations, the motor can further include a sheath that covers the temperature sensor and defines a groove facing the second region of the temperature sensor. In some examples, the coil can be wound in a plurality of turns around the insulator, where the groove of the sheath is in contact with a last turn of the plurality of turns of the coil. In some examples, the first region of the temperature sensor can be in contact with two or more tuns of the plurality of turns of the coil.

In some implementations, the second region of the temperature sensor can be located at an opposite side of the first region of the temperature sensor with respect to a center of the temperature sensor.

In some implementations, a last turn of the coil can be located at an outer end of the insulator. In some implementations, the last turn of the coil can be wound around the temperature sensor in a state in which the temperature sensor is inserted between a first turn of the coil and the last turn of the coil. In some implementations, a space can be defined by a last turn of the coil, another turn of the coil, and the temperature sensor.

### BRIEF DESCRIPTION OF THE DRAWINGS

The above and other objects, features and advantages of the present disclosure will become more apparent to those of ordinary skill in the art by describing example implementations thereof in detail with reference to the accompanying drawings.

FIG. 1 is a side cross-sectional view illustrating an example of a motor.

FIG. 2 is a view illustrating an example of a sensor part.

FIG. 3 is a view illustrating an example of a coil, a temperature sensor, and a heat transfer structure of the temperature sensor that are disposed in the motor.

FIG. 4 is a side cross-sectional view illustrating the coil, on which the temperature sensor is mounted, and an insulator.

FIG. 5 is a front cross-sectional view illustrating the coil, on which the temperature sensor is mounted, and the insulator.

FIG. 6 is a view illustrating an example of a coil, a temperature sensor, and a heat transfer structure of the temperature sensor that are disposed in the motor.

FIG. 7 is a view illustrating an example of a fixing member for fixing the temperature sensor.

FIG. 8 is a perspective view illustrating an example of the fixing member for fixing the temperature sensor.

FIG. 9 is a view illustrating an example of a heat transfer member.

FIG. 10 is a side cross-sectional view illustrating an example of the fixing member for fixing the temperature sensor.

FIG. 11 is a view illustrating an example of a sensor part of the motor.

FIG. 12 is a side cross-sectional view illustrating the sensor part illustrated in FIG. 11 mounted on a coil.

FIGS. 13A and 13B are views showing an example comparison between a temperature of a coil measured in a motor according to a comparative example and a temperature of a coil measured in a motor according to the present disclosure.

FIGS. 14A and 14B show graphs showing an example comparison between a temperature measurement deviation of coils of motors according to comparative examples and a temperature measurement deviation of coils of motors according to the present disclosure.

FIG. 15 shows graphs showing an example comparison between a measured temperature of a coil and a torque of a motor.

### DETAILED DESCRIPTION

Hereinafter, one or more implementations are described in detail with reference to the accompanying drawings, components that are the same or correspond to each other will be denoted by the same or corresponding reference numerals in all drawings, and redundant descriptions will be omitted.

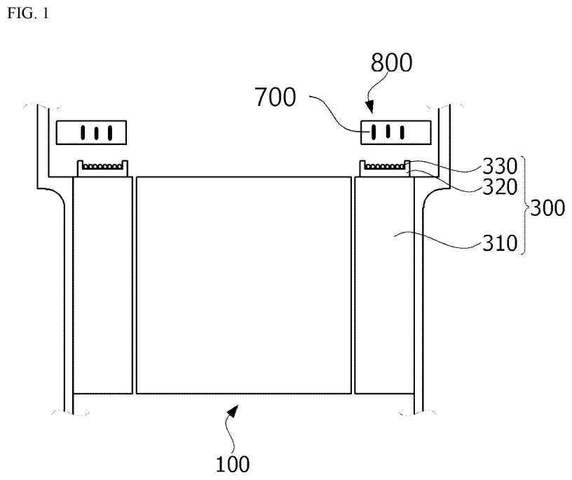

FIG. 1 is a side cross-sectional view illustrating an example of a motor.

Referring to FIG. 1, in some implementations, the motor can include a rotor and a stator. A rotor 100 is rotated due to an electromagnetic interaction with a stator 300.

The rotor 100 can include a rotor core and a magnet coupled to the rotor core. However, the present disclosure is not limited thereto, and the rotor 100 can be variously changed according to an apparatus in which the motor is mounted.

The stator 300 can be located to face the rotor 100. The stator 300 can be located outside the rotor 100 in a radial direction. The stator 300 can include a stator core 310, an insulator 320 mounted on the stator core 310, and a coil 330 wound around the insulator 320.

The stator core 310 can be one member or a combination of a plurality of divided cores. In some examples, the stator core 310 can include a plurality of thin steel plates are stacked on each other. In some examples, the stator core 310 can be formed as a single part.

The insulator 320 is mounted on the stator core 310, insulates the coil 330 from the stator core 310, and provides a space in which the coil 330 is seated.

The coil 330 can be wound in a plurality of turns around the insulator 320.

The motor can include a busbar 700. The busbar 700 can be disposed on one side of the stator 300. The busbar 700 is electrically connected to the coil 330. In addition, the busbar 700 can be connected to an external power source. The busbar 700 can be accommodated in a busbar mold 800.

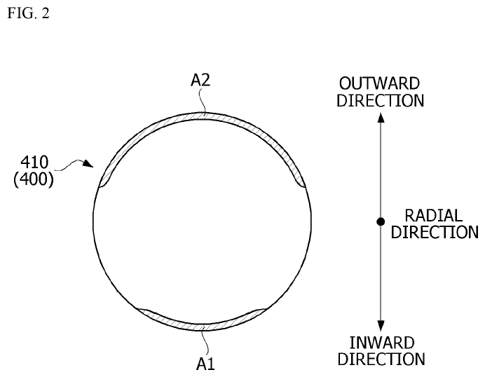

FIG. 2 is a view illustrating a sensor part 400.

The motor can further include the sensor part 400 including a sensor configured to measure a temperature of the coil 330. The sensor part 400 can be in contact with the coil 330, measure the temperature of the coil 330, and transfer the measured temperature to a controller.

In some implementations, referring to FIG. 2, the sensor part 400 can include a temperature sensor 410. Hereinafter, regions which are separated from each other in a circumferential direction of the temperature sensor 410 when the temperature sensor 410 is viewed from the front are defined as a first region A1 and a second region A2. For example, the region which is located inside the temperature sensor 410 in the radial direction of the motor and is in contact with the coil 330 is defined as the first region A1, and the region which is located outside the temperature sensor 410 and is in contact with the coil 330 or separate insulating member is defined as the second region A2.

As illustrated in FIG. 2, when the temperature sensor 410 is viewed from the front, the second region A2 can be located at an opposite side of the first region A1. The first region A1 of the temperature sensor 410 is a region which is in direct contact with the coil 330 and receives heat from the coil 330, and the second region A2 is a region which is in direct contact with the coil 330 or separate insulating member.

The first region A1 and the second region A2 of the temperature sensor 410 can be defined according to characteristics of regions which receive heat from the coil 330 and insulate the heat in order to more accurately measure a temperature of the coil 330. Hereinafter, the first region A1 and the second region A2 will be defined through implementations which will be described below.

In some examples, the temperature sensor 410 illustrated in FIG. 2 is illustrated as a circular shape when viewed from the front, the present disclosure is not limited thereto, and the temperature sensor 410 can be formed in any one of various shapes such as an elliptical shape and a prismatic shape.

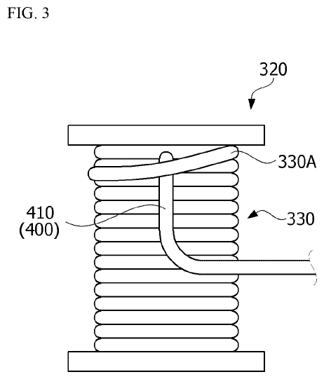

FIG. 3 is a view illustrating an example of a temperature sensor 410, a coil 330 for implementing a first region A1 and a second region A2 implemented in the temperature sensor 410, and a heat transfer structure of the temperature sensor 410 which are disposed in the motor.

The temperature sensor 410 can be mounted to be in direct contact with the coil 330 to measure a temperature of the coil 330. FIG. 3 is a view illustrating the coil 330 wound around an insulator in an axial direction, and the temperature sensor 410 can be located just on the coil 330 to be in contact with the coil 330. In this case, the coil 330 can be wound in a plurality of turns around an insulator 320. The temperature sensor 410 can be mounted on the coil 330 such that the temperature sensor 410 is in contact with at least two turns of the coil 330. To this end, a bent long portion of the temperature sensor 410 in a radial direction can be in contact with the coil 330.

However, the present disclosure is not limited thereto, and the temperature sensor 410 can be mounted in contact with one turn of the coil 330.

When the temperature sensor 410 is mounted on the coil 330, an inner side of the temperature sensor 410 can be in naturally contact with the coil 330, and the inner side of the temperature sensor 410 can directly receive heat through the coil 330. However, an outer side of the temperature sensor 410 is exposed without being in contact therewith. In some implementations, a coil 330A at the last turn can be wound to cover the temperature sensor 410 such that the temperature sensor 410 is fixed to the coil 330 and the outer side of the temperature sensor 410 is also in contact with the coil 330A.

In FIG. 3, although the coil 330A at the last turn is located on an outer end of the insulator 320, the present disclosure is not limited thereto, and the coil 330A at the last turn can be located on a central portion or an inner end of the insulator 320 in the radial direction. A mounting location of the temperature sensor 410 can be changed according to a location of the coil 330A at the last turn.

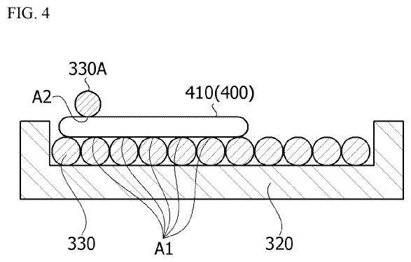

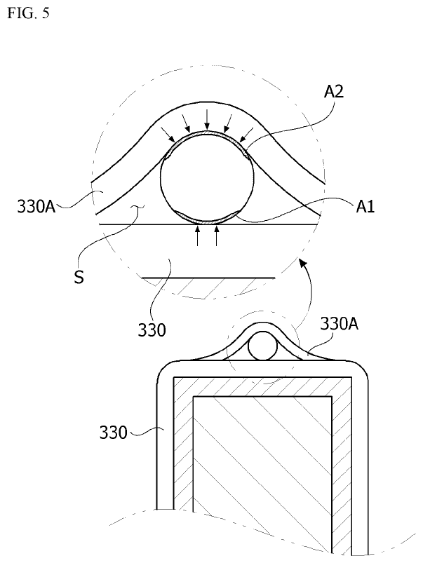

FIG. 4 is a side cross-sectional view illustrating the coil 330, on which the temperature sensor 410 is mounted, and the insulator 320, and FIG. 5 is a front cross-sectional view illustrating the coil 330, on which the temperature sensor 410 is mounted, and the insulator 320.

Referring to FIGS. 3 to 5, the inner side of the temperature sensor 410 is in contact with the coil 330 at the plurality of turns. A portion of an inner region of the temperature sensor 410 in contact with the coil 330 corresponds to the first region A1. In addition, the outer side of the temperature sensor 410 is in contact with the coil 330A at the last turn. A portion of an outer region of the temperature sensor 410 in contact with the coil 330A at the last turn corresponds to the second region A2. Since the first region A1 and the second region A2 are in contact with the coil 330 as described above, the heat of the coil 330 is transferred to the temperature sensor 410 not only from the first region A1 but also from the second region A2, and the heat transferred to the temperature sensor 410 can be naturally prevented from being radiated to the outside of the temperature sensor 410. As a result, the temperature sensor 410 can more accurately measure a temperature of the coil 330. Since the coil 330A at the last turn is wound in a state in which the temperature sensor 410 is covered thereby, a space S can be formed between the coil 330A at the last turn, the remaining coil 330, and the temperature sensor 410.

Meanwhile, since the coil 330A at the last turn is wound in a state in which the temperature sensor 410 is inserted between the coil 330 in a first turn and the coil 330A at the last turn, the temperature sensor 410 can be fixed to the coil 330 by the coil 330A at the last turn without using an additional adhesive.

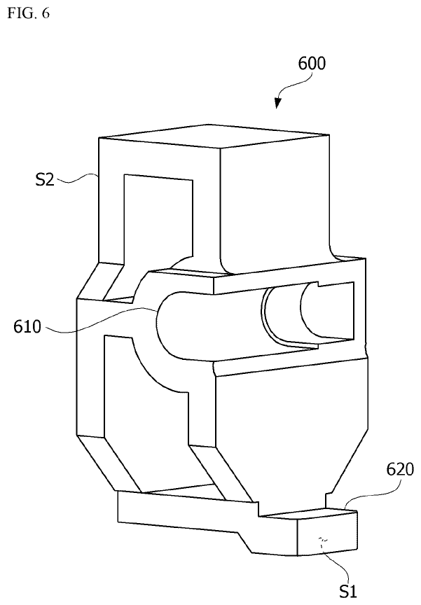

FIG. 6 is a view illustrating a temperature sensor 410, a coil 330 for implementing a first region A1 and a second region A2 implemented in the temperature sensor 410, and a heat transfer structure of the temperature sensor 410 that are disposed in a motor.

In some implementations, the motor can include a fixing member 600 for fixing the temperature sensor 410 to the coil 330. The fixing member 600 can be formed of an insulating member and mounted on the coil 330 in a state in which the temperature sensor 410 is accommodated therein such that the temperature sensor 410 is in contact with the coil 330.

The fixing member 600 can include an accommodation groove 610 which accommodates the temperature sensor 410. The accommodation groove 610 can be concavely formed in one surface of the fixing member 600. The accommodation groove 610 can have a shape corresponding to an outer surface of the temperature sensor 410. For example, the accommodation groove 610 can have a semi-cylindrical curved surface. The accommodation groove 610 can be disposed to face the coil 330 in a state in which the fixing member 600 is mounted on the coil 330. In addition, the fixing member 600 can include a protruding portion 620. The protruding portion 620 can protrude in an axial direction. The protruding portion 620 can include a first surface S1.

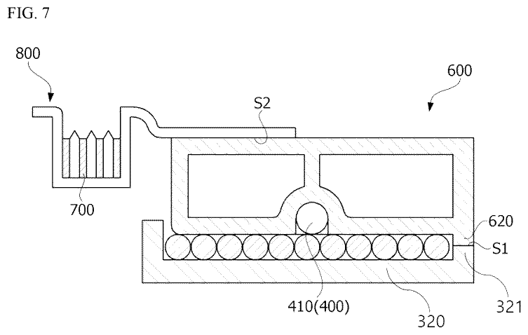

FIG. 7 is a view illustrating the fixing member 600 for fixing the temperature sensor 410.

Referring to FIG. 7, the fixing member 600 fixes the temperature sensor 410 such that the temperature sensor 410 is in contact with the coil 330. The fixing member 600 can be disposed between a busbar mold 800 and an insulator 320, one side thereof can be supported by the busbar mold 800, and the other side thereof can be supported by the insulator 320. The protruding portion 620 of the fixing member 600 can include the first surface S1, and the first surface S1 can be in contact with an inner guide 321 of the insulator 320. For example, the inner guide 321 of the insulator 320 can include protrusions that protrude toward the fixing member to define an accommodation recess that accommodate turns of the coil. In addition, the fixing member 600 can include a second surface S2 in contact with the busbar mold 800. The second surface S2 can be spaced apart from the first surface S1 in the axial direction and can be in contact with the busbar mold 800. The fixing member 600 can be located between the busbar mold 800 and the insulator 320 in the axial direction.

The first surface S1 and the second surface S2 can be coated with an adhesive or can be formed to have a constrained coupling structure engaged with each other.

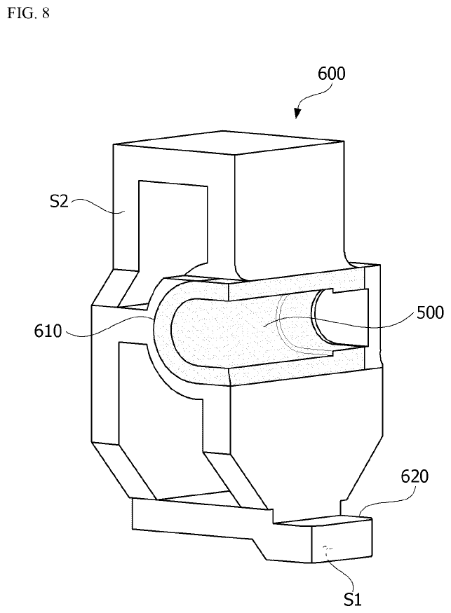

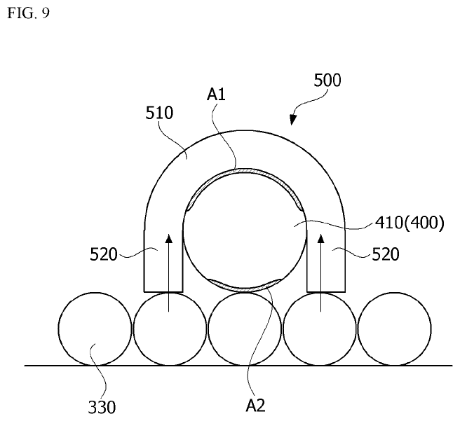

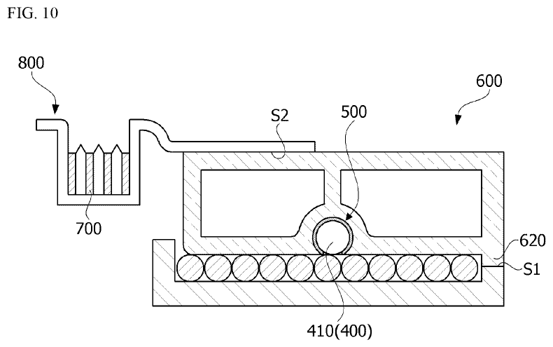

FIG. 8 is a perspective view illustrating an example of a fixing member 600 for fixing a temperature sensor 410, FIG. 9 is a view illustrating a heat transfer portion 500, and FIG. 10 is a side cross-sectional view illustrating the example of the fixing member 600 for fixing the temperature sensor 410.

Referring to FIGS. 8 to 10, the fixing member 600 may include the heat transfer portion 500. The heat transfer portion 500 can be disposed in an accommodation groove 610 of an insulating member. The heat transfer portion 500 can include a cylindrical curved surface corresponding to a shape of the accommodation groove 610. The heat transfer portion 500 is in contact with the temperature sensor 410 accommodated in the accommodation groove 610. The heat transfer portion 500 functions to uniformly distribute heat transferred from a coil 330 to the temperature sensor 410.

The heat transfer portion 500 can include a curved portion 510 and an extension portion 520. The curved portion 510 can include a curved surface which has a curvature the same as a curvature of an outer surface of the temperature sensor 410 and is in contact with the temperature sensor 410. The extension portion 520 can extend from the curved portion 510 and can be disposed to be spaced apart from the temperature sensor 410. The extension portion 520 can extend from each of both ends of the curved portion 510. In a state in which the fixing member 600 is fixed to the coil 330, an end portion of the extension portion 520 can be in contact with the coil 330.

In a state in which a first region A1 of the temperature sensor 410 is in contact with the coil 330, the heat transfer portion 500 is in contact with the coil 330. Heat transferred to the heat transfer portion 500 from the coil 330 can be uniformly transferred to an entirety of the heat transfer portion 500, and the heat transferred to the heat transfer portion 500 is uniformly transferred to the temperature sensor 410. In addition, the heat transferred to the heat transfer portion 500 is prevented from escaping to the outside by the insulating member.

As described above, since a temperature of the coil 330 is uniformly transferred in a second region A2 in addition to the first region A1 of the temperature sensor 410 in contact with the coil 330, the sensor part 400 can accurately measure the temperature of the coil 330.

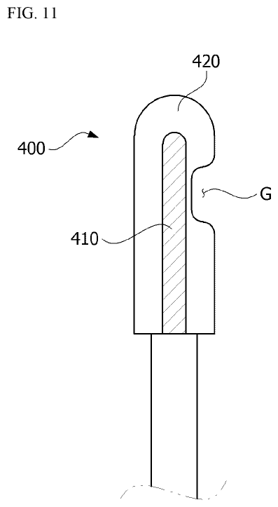

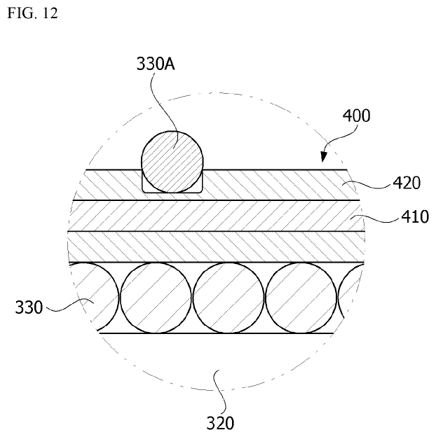

FIG. 11 is a view illustrating an example of a sensor part 400 of a motor, and FIG. 12 is a side cross-sectional view illustrating a state in which the sensor part 400 illustrated in FIG. 11 is mounted on a coil 330.

Referring to FIGS. 11 and 12, in some implementations, the sensor part 400 of the motor can further include a sheath part 420 which covers a temperature sensor 410. The sheath part 420 can include a groove G. The sheath part 420 can be concavely formed in an outer surface of the groove G. The groove G fixes a location of a coil 330A at the last turn when the coil 330A at the last turn is wound around the temperature sensor 410 and functions to increase a fixing force between the coil 330A and the sensor part 400.

An outer side of the temperature sensor 410 is in contact with the coil 330A at the last turn, and a partial outer region of the temperature sensor 410 in contact with the coil 330A at the last turn corresponds to a second region A2. In this case, the coil 330A at the last turn is inserted into the groove G of the sheath part 420 to fix the location of the coil 330A at the last turn. In the sensor part 400, since the second region A2 is also in contact with the coil 330 along with a first region A1, the heat of the coil 330 is transferred to the temperature sensor 410 not only from the first region A1 but also from the second region A2 of, the heat transferred to the temperature sensor 410 can be naturally prevented from being radiated to the outside of the temperature sensor 410.

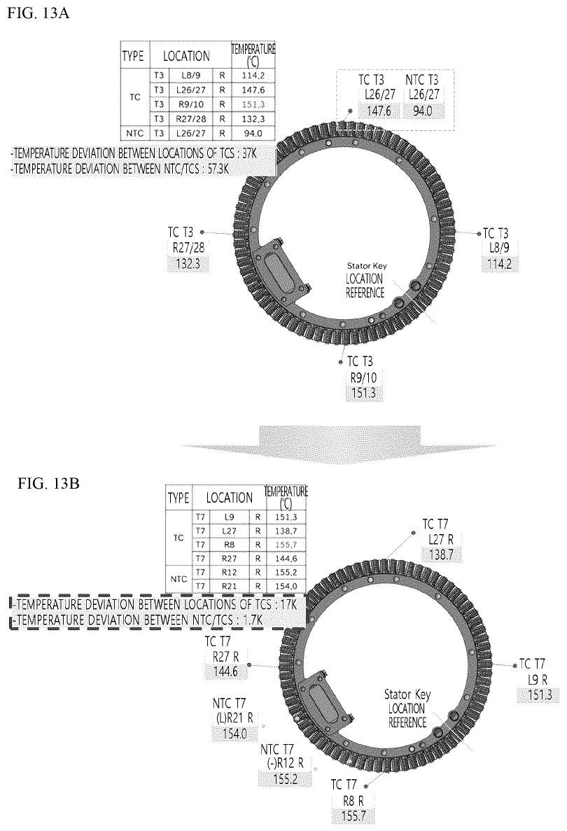

FIGS. 13A and 13B are views showing an example comparison between a temperature of a coil of a comparative example and a temperature of a coil 330 measured in a motor according to the present disclosure.

FIG. 13A shows example temperatures of a coil measured in a comparative example in which a sensor part 400 is fixed to the coil 330 using a general adhesive such as an epoxy. As illustrated in FIG. 13A, thermocouples (TCs) T3 mounted during the test process were mounted on various locations of the coil 330, temperatures of the coil 330 were measured, and a deviation of the temperatures of the coil 330 measured by the TCs T3 was 37 K (Kelvins). In addition, it can be seen that a deviation between the temperatures of the coil 330 measured by the TCs T3 mounted during the test process and the temperatures of a coil 330 measured by thermocouples (NTCs) T3 mounted on an actual product was 57.3 K.

FIG. 13B shows example temperatures of a coil 330 measured in a motor according to the present disclosure. As illustrated in FIG. 13B, in the example, when TCs T7 mounted during the test process were mounted at various locations of the coil 330 to measure temperatures of the coil 330, it can be seen that a deviation between the temperatures of the coil 330 measured by the TCs T7 was 17 K, that is significantly reduced from that of the comparative example. In addition, a deviation between the temperatures of the coil 330 measured by the TCs T7 mounted during the test process and temperatures of a coil 330 measured by NTCs T7 mounted on the actual product was 1 K, and thus it can be seen that the deviation between the measured temperatures of the coil 330 is significantly improved from the comparative example.

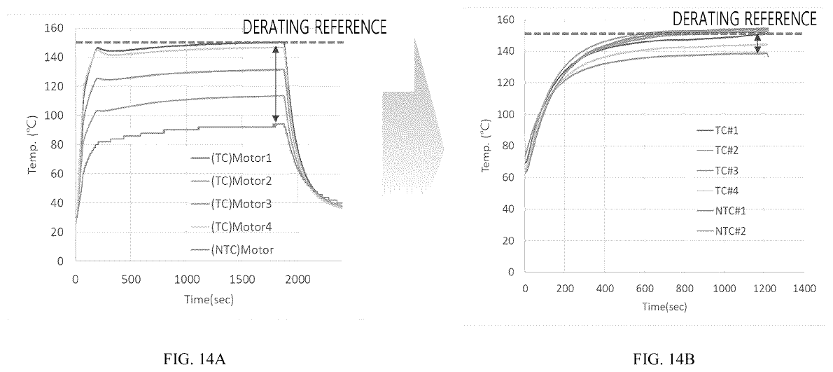

FIGS. 14A and 14B show graphs for comparison between a temperature measurement deviation of the coils 330 of the motors according to comparative examples and a temperature measurement deviation of the coils 330 of the motors according to examples.

FIG. 14A is a graph showing temperatures of coils 330 measured in comparative examples in which sensor parts 400 are fixed to the coils 330 using a general adhesive such as an epoxy. As illustrated in FIG. 14A, a derating of a limit value of output power of a motor is set using a measured temperature of the coil 330, and it can be seen that a deviation between temperatures of the coils 330 measured by TCs motor 1, 2, 3, and 4 mounted during the test process is large, ranging from 90° C. to 160° C. Accordingly, in the case of the comparative examples, there is a limit in securing maximum output power in a process of controlling a motor.

As illustrated in FIG. 14B, it can be seen that a deviation of the temperature of the coils 330 measured by TCs #1, 2, 3, and 4 mounted during the test process is small, ranging from 135° C. to 160° C. when compared to the comparative examples. Accordingly, in the case of the examples, it is advantageous for securing maximum output power in a process of controlling a motor.

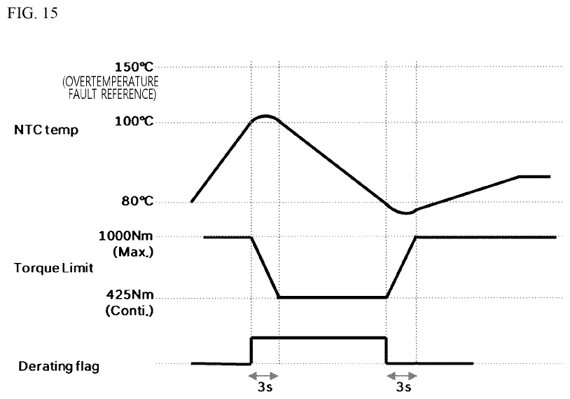

FIG. 15 shows graphs for comparison between a measured temperature of a coil 330 and a torque of a motor.

As illustrated in FIG. 15, in some examples, when an allowable maximum temperature value of the coil 330 is 150° C, the maximum output power of the motor can be secured by maximizing a torque when the measured temperature of the coil 330 is 100° C. or less. When the measured temperature of the coil 330 is greater than 100° C, a torque can be quickly derated. In this case, the derating time can be as short as 3 seconds.

In some implementations, since a temperature sensor is formed to receive a temperature of a coil from the inside and the outside of the temperature sensor in a radial direction, the temperature of the coil of a stator is accurately measured, and thus there is an advantage that the performance of a motor can be optimized.

In some implementations, since a last turn of a coil is formed to cover an outer side of the coil, there is an advantage that a temperature of the coil can be accurately measured.

In some implementations, since a temperature sensor is fixed to a coil using a fixing member having an insulating property, heat transferred from the coil is prevented from being radiated, and thus there is an advantage that a temperature of the coil can be accurately measured.

In some implementations, since a heat transfer member in contact with a temperature sensor is disposed in a fixing member having an insulating property and formed in contact with a coil, heat transferred from the coil is uniformly distributed in the temperature sensor, and thus there is an advantage that a temperature of the coil can be accurately measured.

In some implementations, since a groove is formed in an outer side of a sheath part which covers a temperature sensor and a last turn of a coil is inserted into the groove, there are advantages that a location of the coil at the last turn can be easily guided, and a fixing force between the temperature sensor and the coil at the last turn can be increased.

While the present disclosure has been described above with reference to example implementations, it can be understood by those skilled in the art that various modifications and changes of the present disclosure can be made within a range not departing from the spirit and scope of the present disclosure defined by the appended claims.

What is claimed is:

1. A motor comprising:
a stator comprising (i) a stator core, (ii) an insulator disposed at the stator core, and (iii) a coil wound around the insulator;
a rotor configured to rotate relative to the stator; and
a temperature sensor that is in contact with the coil and configured to measure a temperature of the coil,
wherein the temperature sensor has a first region and a second region that are spaced apart from each other in a circumferential direction of the temperature sensor and that are surrounded by at least one of the coil or an insulating member.

2. The motor of claim 1, wherein the coil is wound in a plurality of turns around the insulator,
wherein the first region of the temperature sensor is in contact with any one turn of the plurality of turns of the coil, and
wherein the second region of the temperature sensor is in contact with another turn of the plurality of turns of the coil.

3. The motor of claim 2, wherein the second region of the temperature sensor is in contact with a last turn of the plurality of turns of the coil.

4. The motor of claim 2, wherein the first region of the temperature sensor is in contact with two or more turns of the plurality of turns of the coil.

5. The motor of claim 1, further comprising a fixing member that comprises an insulating material and provides the insulating member, the fixing member surrounding at least a portion of the temperature sensor and being in contact with the second region of the temperature sensor.

6. The motor of claim 5, wherein the fixing member defines an accommodation groove that accommodates the temperature sensor.

7. The motor of claim 6, wherein the fixing member comprises a heat transfer portion that is accommodated in the accommodation groove and is in contact with the coil, the heat transfer portion being made of a material configured to transfer heat from the coil.

8. The motor of claim 7, wherein the heat transfer portion comprises:
a curved portion comprising a contact region in contact with the temperature sensor, the contact region having a curvature corresponding to a curvature of an outer surface of the temperature sensor; and
an extension portion that extends from the curved portion, that is spaced apart from the temperature sensor, and that is in contact with the coil.

9. The motor of claim 6, wherein the accommodation groove has a semi-cylindrical curved surface.

10. The motor of claim 5, wherein the fixing member has a first surface in contact with the insulator.

11. The motor of claim 10, further comprising:
a busbar connected to the coil; and
a busbar mold that fixes the busbar and is in contact with a second surface of the fixing member.

12. The motor of claim 11, wherein the fixing member comprises a protruding portion that protrudes in an axial direction of the stator and defines the first surface in contact with the insulator.

13. The motor of claim 11, wherein the first surface and the second surface of the fixing member are spaced apart from each other in an axial direction of the stator.

14. The motor of claim 1, further comprising a sheath that covers the temperature sensor and defines a groove facing the second region of the temperature sensor.

15. The motor of claim 14, wherein the coil is wound in a plurality of turns around the insulator, and
wherein the groove of the sheath is in contact with a last turn of the plurality of turns of the coil.

16. The motor of claim 15, wherein the first region of the temperature sensor is in contact with two or more tuns of the plurality of turns of the coil.

17. The motor of claim 1, wherein the second region of the temperature sensor is located at an opposite side of the first region of the temperature sensor with respect to a center of the temperature sensor.

18. The motor of claim 1, wherein a last turn of the coil is located at an outer end of the insulator.

19. The motor of claim 1, wherein a last turn of the coil is wound around the temperature sensor in a state in which the temperature sensor is inserted between a first turn of the coil and the last turn of the coil.

20. The motor of claim 1, wherein a space is defined by a last turn of the coil, another turn of the coil, and the temperature sensor.
